(19) United States
(12) Patent Application Publication
(10) Pub. No.: US 2007/0016747 A1
(43) Pub. Date: Jan. 18, 2007

(54) Computer system and method for improving processing velocity of memory

(75) Inventor: Jin-su Yun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/366,665

(22) Filed: Mar. 3, 2006

(30) Foreign Application Priority Data
Jul. 18, 2005 (KR) 2005-0064735

(51) Int. Cl. G06F 13/00

(52) U.S. Cl. 711/167

(57) ABSTRACT

A computer system and method for improving processing speed of a memory are provided. A memory stores data and includes at least one memory module. A memory controller controls an operation of respective memory modules according to commands from a central processing unit (CPU) and includes a plurality of general counters generating clocks for operating the respective memory modules. Accordingly, the plurality of general counters is provided to generate clocks corresponding to operational features of each memory module, so that each memory module is operated at an improved operational speed. Accordingly, the memory access speed is enhanced.

### CROSS-REFERENCE TO RELATED APPLICATIONS

This application claims the benefit under 35 U.S.C. §119(a) of Korean Patent Application No. 2005-64735, filed Jul. 18, 2005, in the Korean Intellectual Property Office, the entire disclosure of which is hereby incorporated by reference.

### BACKGROUND OF THE INVENTION

1. Field of the invention

The present invention relates to a computer system and method for improving processing speed of a memory. More particularly, the present invention relates to a computer system and method for improving processing speed of a memory capable of generating a clock signal appropriate for an operational feature of each memory module by providing a number of general counters that corresponds to the number of memory modules.

2. Description of the Related Art

Generally, a main board of a computer system, as shown in FIG. 1, has a Central Processing Unit (CPU) 10, a system controller 20 and a memory 40. The CPU 10 controls all devices in the computer system through the system controller 20, including the memory 40.

The system controller 20 includes a CPU bus controller 21, a 12C controller 23, a Peripheral Component Interconnect (PCI) controller 25, and a memory controller 30. The CPU bus controller 21 controls operations of an external bus providing processing results at the CPU to a peripheral device, and an inner bus transferring data within the CPU 10 circuit. The 12C controller 23 controls 12C communication supporting inter-controller communication or communication between each controller and the memory 40. The 12C communication uses a line for a clock signal transmission and a line for data transmission, which are necessary for communication. The PCI controller 25 controls a bus for exchanging data between a peripheral device mounted at a PCI slot and the CPU 10. The memory controller 30 controls the memory 40 in order to store data in the memory 40 or withdraw data from the memory.

The memory controller 30, as shown in FIG. 2, includes a refresh controller 31, a control register 32, a general counter 33, an address generating unit 34, a command creating unit 35, and a data generating unit 36. The refresh controller 31 controls the memory 40 to be refreshed in a refresh cycle. The control register 32 stores a signal needed for controlling the system controller 20. The general counter 33 outputs a clock signal appropriate for an operation for each memory module, and the address generating unit converts a system address into a memory address. The command creating unit 35 gives commands corresponding to the memory address for storing information in the memory module and retrieving information from the memory module. The data generating unit 36 stores and withdraws the data.

The memory 40 is used for storing various data and programs for operating the computer system. The memory has several banks provided as a module form that includes a standard interface. The memory module 45 provided in the module form, as shown in FIG. 1, includes a volatile memory device 46 and a non-volatile memory device 48. The volatile memory device 46 is used to store programs and data, and the non-volatile memory device 48 is used to store information regarding the operational feature of each memory module 45. The operational feature information includes RAS (Row Address Strobe) to CAS (Column Address Strobe), CAS Latency, a refresh cycle, access time, precharge time, memory capacity, and a number of rows and columns.

In an initialization of the computer system, the CPU 10 of the computer system accesses the non-volatile memory device 48 in each memory module and reads the operational feature information of the memory module 45. At this time, the non-volatile memory device 48 is controlled by the 12C controller 23 of the system controller 20. The CPU 10 controls the memory module 45 through the memory controller 30 according to the operational features of the read memory.

Operation timing-related information, from the operational features of the memory module 45 read by the CPU 10, for example, RAS to CAS and CAS Latency, are important for determining an operation speed of the memory 40.

Generally, one computer system has a plurality of memory modules 45. On the other hand, respective memory modules 45 may have almost the same operational feature or different operational features regardless of whether the computer system and memory modules have the same standards or come from the same manufacturer. Therefore, it is unreasonable to operate respective memory modules 45 according to one operational feature for operation when the operational features are different.

For example, if RAS to CAS and CAS Latency of one memory module are operated for 3 clocks, respectively, RAS, CAS and DATA, in accordance with the clocks, are operated in wave forms as shown in FIG. 3A. That is, RAS to CAS are operated for 3 clocks, so delay time between RAS and CAS is 3 clocks. CAS Latency is operated for 3 clocks, so data is transmitted 3 clocks after CAS occurs. Accordingly, a time of at least 6 clocks are needed for data transmission.

If RAS to CAS and CAS Latency of another memory module are operated for 2 clocks, respectively, delay time between RAS and CAS is 2 clocks, and CAS Latency is 2 clocks, as shown in FIG. 3B. Accordingly, at least 4 clocks are needed to transmit data.

When a plurality of memory modules 45 has different operational features, the CPU 10 operates in accordance with the operational speed of the slowest memory module 45. That is, the CPU 10 controls respective memory modules 45 according to the operational speed of 3 clocks. The CPU 10 controls the memory modules according to the operational speed of the slowest memory module 45 because one general counter 33 exists in the memory controller 30. Generally, the general counter 33 is capable of counting one clock signal. However, when respective memory modules 45 have different operation speeds, the general counter 33 counts the clock signal according to the slowest operational speed. Accordingly, the CPU 10 controls the memory according to the operational speed of the clock counted by the general counter, that is, in accordance with the slowest memory module 45. If the memory module 45 with a quick operational speed is provided, the operation is performed at the operational speed of the slowest memory module 45. Therefore, the operational speed of the memory module 45 can not be used at a maximum.

### SUMMARY OF THE INVENTION

An aspect of embodiments of the present invention is to address at least the above problems and/or disadvantages and to provide at least the advantages described below. Accordingly, an aspect of embodiments of the present invention is to provide a computer system for improving a processing speed of a memory by controlling an operation of the memory module according to operational features of memory modules, when a plurality of memory modules is mounted.

In order to achieve the above-described aspects of the present invention, there is provided a computer system for improving a processing speed of a memory comprising a memory for storing data, including at least one memory module. A memory controller controls an operation of the memory module according to commands from a Central Processing Unit (CPU), and wherein the memory controller includes a plurality of general counters generating clocks for operating memory modules.

The general counters provided corresponds to the same number as the memory modules provided, so that the general counters and memory modules may correspond one by one.

The general counters generate a clock signal appropriate for operational features of the corresponding memory modules read by the CPU.

The operational features may include at least one of RAS to CAS, CAS Latency, refresh cycle, access time, precharge time, memory capacity, or number of rows and columns.

The general counters generate clocks in accordance with an operational speed of RAS to CAS and CAS Latency, determined by the operational features of the corresponding memory modules.

### BRIEF DESCRIPTION OF THE DRAWING FIGURES

The above and other objects, features, and advantages of certain exemplary embodiments of the present invention will become more apparent from the following description taken in conjunction with the accompanying drawings, in which:

FIG. 1 is a structural block diagram of a conventional computer system;

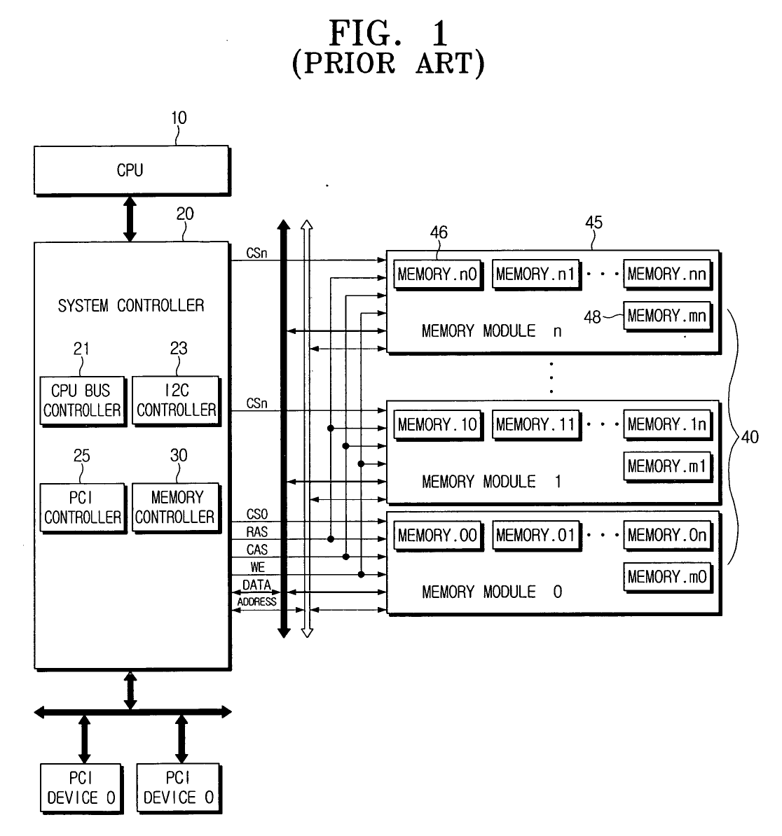

FIG. 2 is a structural block diagram of a conventional memory controller;

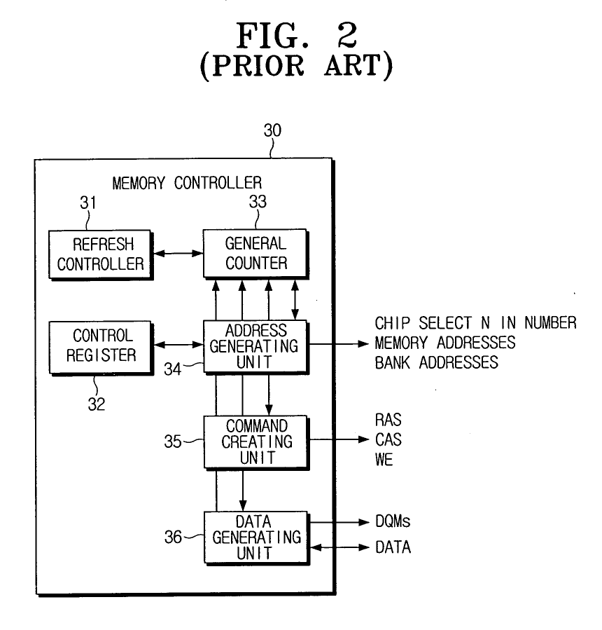

FIG. 3A illustrates waveforms of a clock, RAS, CAS and DATA when RAS to CAS and CAS Latency, which are operated for 3 clocks, respectively;

FIG. 3B illustrates waveforms of a clock, RAS, CAS and DATA when RAS to CAS and CAS Latency, which are operated for 2 clocks, respectively; and

FIG. 4 is a structural block diagram of memory controller according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

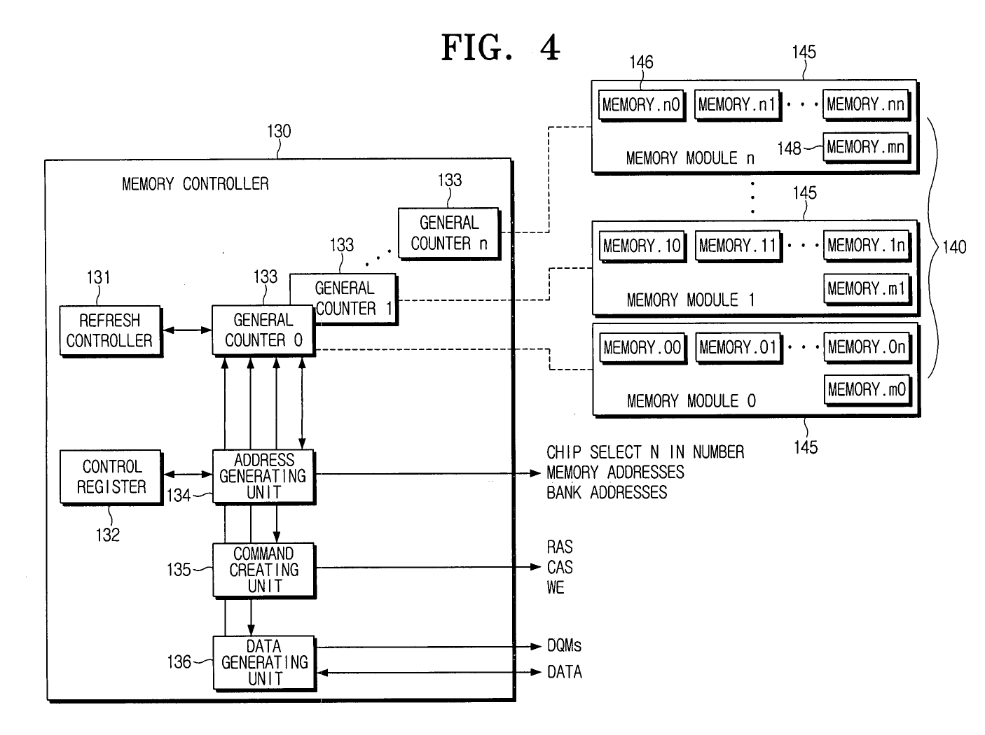

FIG. 4 is a structural memory controller according to an exemplary embodiment of the present invention. As illustrated in FIG. 4, a memory 140 includes a plurality of memory modules 145 (memory modules 0, 1, . . . n). The memory modules 145 include a volatile memory device 146 storing a program and data, and a non-volatile memory device 148 storing information regarding operational features of respective memory modules 145.

The operational feature information stored in the non-volatile memory device 148 includes CAS Latency, which is time taken to find an accurate address of a memory array after receiving RAS to CAS, and CAS, which is transmission time differences between RAS, a memory array row address, and a CAS, a column memory array column address; refresh cycle providing a recharging cycle of the memory 140, access time taken to approach the memory 140 in order to store data at the memory 140 and withdraw data from the memory 140,precharge time which is a time difference between data withdrawal at one address number and another address number; memory capacity; and a number of rows and columns.

Respective memory modules 145 may not include the non-volatile memory device 148. In this instance, the operational feature information of the memory modules 145 is stored in a separate program of the system. A CPU may retrieve the operational feature information from the program and control the memory 140.

A memory controller 130, supporting interface between the respective modules 145 and the CPU, as illustrated in FIG. 4, includes a refresh controller 131, a control register 132, a plurality of general counters 133 (general counter 0, 1, . . . n), an address generating unit 134, a command creating unit 135, and a data generating unit 136.

The refresh controller 131 controls the memory 140 to be refreshed according to a refresh cycle of the memory 140. A refresh work refers to a recharging process of each memory cell of the memory 140. Memory cells in a column are charged by a once-refresh work. The refresh cycle includes time taken to refresh a memory column or an entire memory array. Generally, a column is charged in a refresh cycle.

The control register 132 temporarily stores a command or data needed for controlling the memory 140.

The plurality of general counters 133 (general counter 0, 1, . . . n) correspond to the respective memory modules 145 (memory module 0, 1, . . . n) one by one. One general counter 133 counts clocks according to the operational feature of one memory module 145. That is, a number of general counters 133 are provided, corresponding to the number of the memory modules 145. The memory modules 145 may be added by a user. However, it is important to provide as many general counters as the maximum number of the memory modules supported by the memory controller 130.

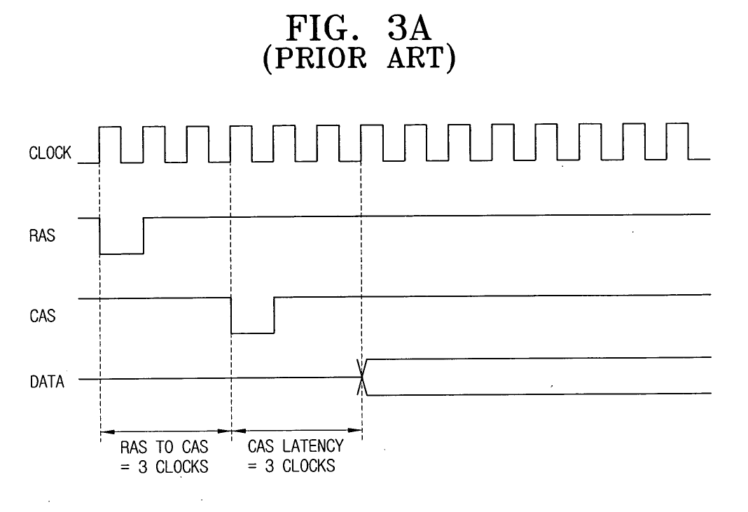

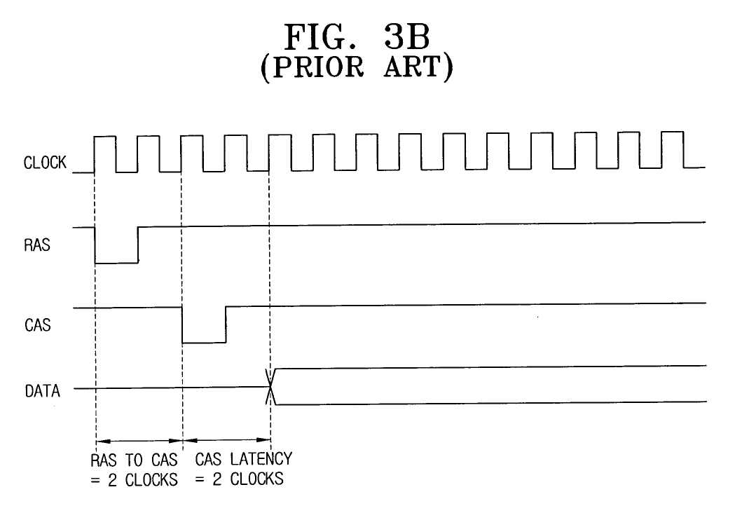

Each general counter 133 counts clocks in accordance with the corresponding memory module 145. The general counters 133 corresponding to the memory modules are used to count clocks when controlling the selected memory modules 145. For example, as shown in FIG. 3A, if RAS to CAS and CAS Latency of the memory module (1) are operated for 3 clocks, respectively, the general counter (1) counts a clock speed of the memory module (1) as 3 clocks according to the operational speed of RAS to CAS and CAS Latency of the memory module (1). Accordingly, the CPU controls the general counter (1) corresponding to the memory module (1).

As shown in FIG. 3B, if RAS to CAS and CAS Latency of a memory module (2) are operated at 2 clocks, respectively, a general counter (2) counts the clock speed as 2 clocks according to the operational velocity of RAS to CAS and CAS Latency of the memory module (2). The CPU operates the general counter (2) at a clock speed corresponding to the operational speed of the memory module (2), in order to control the memory module (2) at the operational speed of the memory module (2).

The number of general counters 133 existing in the memory controller 130 corresponds to the number of memory modules 145. The CPU controls each memory module 145 at the operational speed determined by the operational feature of each memory module 145.

In order to find data or an address at the memory 140, the address generating unit 134 analyzes a request from the CPU, converts a system address into a memory address, and selects a memory chip corresponding to the memory modules 145. The address generating unit 134 receives the system address of the memory module 145 selected by the CPU and provides the system address to a system controller 20. The address generating unit 134 converts the provided system address into the memory address expressed in a row and column. The address generating unit 134 selects a memory module 145 corresponding to the converted memory address, and the memory chip including the corresponding memory module 145.

The command creating unit 135 transmits corresponding RAS, CAS and Write Enable (WE) to the memory modules 145, according to the memory address in the address generating unit 134, and locates the memory modules 145 so that data is input and output. WE refers to a signal transmitted for storing data in the memory, which is transmitted to the memory modules 145 only when the data is stored.

The data generating unit 136 stores data in a corresponding memory module located by the command creating unit 135 or withdraws data from the corresponding memory module, and transmits a Data Mask (DQM) signal together when inputting and outputting data. The DQM signal indicates whether the data is accurate, and the memory modules 145 prevent data from being input and output when the DQM signal indicates the data is not accurate.

Hereinafter, an initialization process will be described below, and a process for storing data in the memory or retrieving the data from the memory in the structured computer system.

At the initialization process, the CPU controls a 12C controller to withdraw information, regarding the operational feature from a non-volatile memory device 148 of each memory module 145. The CPU sets each general counter 133 to operate at clocks corresponding to the memory module 145, according to the number of clocks needed to operate RAS to CAS and CAS Latency of each memory module 145.

When the operational clock speed of each general counter 133 is set and data input or output is needed, in accordance with the memory, the CPU provides, to the address generating unit 134 of the memory controller 130, the system address indicating where a requested memory module 145 is located, through the system controller. The address generating unit 134 decodes the system address and converts the system address into a memory address expressed in a row and column.

If the memory address is generated, the information regarding the generated memory address is provided to each general counter 133. Among the plurality of general counters 133, the general counters 133 corresponding to the memory modules 145, having a corresponding memory address, are operated. For example, when the converted memory address belongs to a memory module (3), a general counter (3), corresponding to the memory module (3), is operated, and the clock signal is generated.

The command creating unit 135 transmits RAS, CAS and WE to the memory address converted at the address generating unit 134 so that the corresponding memory modules 145 are selected. The command creating unit 135 transmits RAS, CAS and WE in synchronization with the clocks generated from the selected general counter 133. If the memory modules 145 are accurately located, according to RAS and CAS transmitted by the command creating unit 135, the data generating unit 136 transmits data to the corresponding memory modules 145 or retrieves the data from the memory modules 145. Data transmission or retrieval by the data generating unit 136 is performed in synchronization with the clocks generated from the general counters 133.

The computer system includes the plurality of general counters 133 to correspond to the plurality of memory modules 145, and the CPU controls the memory modules 145 and operational speed, according to operational features of each memory module 145.

In transmitting RAS and CAS, or inputting and outputting data, the CPU operates the memory modules 145 through the general counter 133, which generates clocks from the operational speed of the selected memory modules 145. Accordingly, the computer system operates each memory module 145 at an improved operational speed and improves overall memory access speed.

According to the above exemplary embodiments, a Dynamic Ram (DRAM) is provided, which requires a refresh operation in a predetermined cycle in order to not erase information. However, exemplary embodiments of the present invention may be provided with a Static Ram (SRAM), which does not erase information as long as power is on. As a result, the SRAM does not need a refresh controller.

According to the above exemplary embodiments, the memory 140 is divided in a unit of the memory module 141. However, exemplary embodiments of the present invention may be applied where the memory 140 is divided in a bank unit. In this instance, the address generating unit 134 generates the memory address into a bank address.

As described above, exemplary embodiments of the present invention provides a plurality of general counters to generate clocks corresponding to operational features of each memory module, so that each memory module is operated at an improved operational speed. Accordingly, the memory access speed is enhanced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A computer system comprising:
a memory for storing data, comprising at least one memory module; and
a memory controller for controlling an operation of the at least one memory module according to commands from a Central Processing Unit (CPU), and wherein the memory controller comprises at least one general counter for generating clocks for operating the at least one memory module.

2. The computer system of claim 1, further comprising a plurality of memory modules, wherein general counters are provided in a one to one correspondence to the memory modules.

3. The computer system of claim 2, wherein the general counters generate clocks fitting operational features of the respective corresponding memory module read by the CPU.

4. The computer system of claim 3, wherein at least one of the operational features comprise at least one of Row Address Strobe (RAS) to Column Address Strobe (CAS), CAS Latency, a refresh cycle, access time, precharge time, memory capacity, and number of rows and columns.

5. The computer system of claim 4, wherein at least one of the general counters generate the clocks in accordance with an operational speed of RAS to CAS and CAS Latency determined by the operational feature of the corresponding memory module.

6. The computer system of claim 1, further comprising an address generating unit for converting a system address into a memory address, and providing the memory address to the at least one general counter.

7. The computer system of claim 6, wherein the at least one general counter corresponds to a memory module comprising a corresponding memory address.

8. The computer system of claim 6, further comprising a command creating unit for transmitting the operational feature to a memory address in synchronization with the clock generated, in order to select the corresponding memory module.

9. The computer system of claim 8, further comprising a data generating unit for storing data in or retrieving data from the selected memory module, in synchronization with the generated clock.

10. A method for processing data in a computer system, the method comprising:
storing data in a memory comprising memory modules;
controlling an operation of the memory modules according to commands from a CPU; and
generating clocks for operating the memory modules, respectively.

11. The method of claim 10, wherein the clocks are generated by general counters corresponding to the memory modules respectively.

12. The method of claim 11, wherein the general counters generate clocks appropriate for operational features of the corresponding memory modules read by the CPU.

13. The method of claim 10, further comprising converting a system address into a memory address and providing the memory address to the general counters.

14. The method of claim 13, wherein the general counters correspond with the memory modules comprising a corresponding memory address.

15. The method of claim 14, further comprising transmitting the operational features to a memory address in synchronization with the clocks generated, in order to select the corresponding memory module.

16. The method of claim 15, further comprising storing data in or retrieving data from a selected memory module, in synchronization with generated clocks.
